(19) United States
(12) Patent Application Publication
(10) Pub. No.: US 2013/0308894 A1
(43) Pub. Date: Nov. 21, 2013

(54) Deployment of fibre optic cables and joining of tubing for use in boreholes

(71) Applicant: Philip Head, Egham (GB)

(72) Inventor: Philip Head, Egham (GB)

(21) Appl. No.: 13/980,623

(22) PCT Filed: Jan. 20, 2012
(86) PCT No.: PCT/IB12/00174

§ 371 Date: Jul. 19, 2013

(30) Foreign Application Priority Data
Jan. 20, 2011 (GB) 1100988.3

(51) Int. Cl. G01V 8/10

(52) U.S. Cl. CPC G01V 8/10
USPC 385/12

(57) ABSTRACT

A Deployment of fibre optic cables and joining of tubing for use in boreholes. A self supporting fibre optic cable (2, 14′) is slidingly deployed in a borehole via a small diameter conduit (1, 2′) which may be perforated to enable distributed sensing over at least part of the length of the cable. The cable may comprise a casing made from plural concentric tubular steel layers with aligned perforations. In another embodiment, a cable is deployed via wellhead valving and suspended from a fixture comprising a pulley assembly located beneath the valving. The pulley assembly takes up slack in the cable when the upper end of the cable is released, allowing the cable to fall through the valving so that the valving can be closed. The upper end of the cable includes a termination which is located by the fixture so that it can be retrieved. In an other embodiment, two concentric tubing portions are joined by forming dimples in the inner tubing portion which extend into holes the outer tubing portion.

This invention relates to the deployment of fibre optic cables in boreholes, for example, for data transmission or distributed sensing in oil and gas wells, and to methods and apparatus for joining tubing for use in boreholes.

A fibre optic cable is a cable including at least one optical fibre. It is well known in the oil and gas industry to employ downhole distributed sensing systems using fibre optic cables to measure local variations in ambient temperature, pressure, flow rate, seismic or acoustic vibrations, or other parameters at different points in a borehole. Depending on the sensing methodology, variations in the inherent optical characteristics of the optical fibre corresponding to local variations in the measured parameter may be sensed continuously along its length. Alternatively, discrete optical discontinuities may be formed at specific points along the length of the fibre, for example as Bragg gratings. Measurable variations in the optical characteristics of the fibre may result from strain induced in the fibre by variations in the measured parameter. The fibre can be interrogated from the surface using a laser so as to sense local variations in the optical characteristics of the fibre at any desired position along the whole or a selected part of the length of the fibre, which may extend for many kilometres, from which the local value of the sensed parameter may be derived with a positional resolution of as little as 1 m or even less.

For example, the fibre optic cable may be configured as a distributed temperature sensing system, wherein the optical fibre is used to sense temperature as a continuous variable over the length of the fibre by means of optical time domain reflectometry or optical frequency domain reflectometry.

Fibre optic cables are also used for data transmission, for example, to carry signals between surface monitoring or control equipment and a downhole sensor or other equipment deployed in the borehole.

Conventionally, a fibre optic cable is strapped to the outside of production tubing and deployed into the borehole together with the production tubing from a rig.

If the fibre optic cable is to be used to carry out distributed sensing across the productive formation forming the reservoir within the borehole, it is necessary to strap the fibre optic cable to the production tailpipe, and to extend the tailpipe across the reservoir, which may be inconvenient. Alternatively, a fibre optic cable can be included in the casing or sand screen across the reservoir and terminated with a optical wet connect (i.e. a connector for jointing the optical fibre of the cable in situ to another optical fibre or optical conductor while immersed in the well fluid). Then when the production tubing is deployed with a second fibre optic cable it has to be orientated to the correct rotational position and then landed to engage the optical wet connect. This can be difficult to accomplish successfully.

It is known to form a connection between two portions of tubing, e.g. well casing, production tubing or sandscreen, by inserting the end of one tube into the other tube and then expanding the inner tube using a swaging tool so as to form a tight frictional joint between them. This technique can be used for example to join lengths of tubing together to form a sandscreen before deploying the joined lengths in the borehole. Prior to deployment, a fibre optic cable may be arranged to extend across the entire length of the sandscreen so as to provide distributed sensing across the depth of the productive formation. However, the frictional joint provides only limited resistance to axial and torsional stress, and any subsequent rotation between the joined tubing lengths during or after deployment may damage or destroy the cable.

A further problem is that fibre optic cable deployed in oil and gas wells gradually darkens due to exposure to H₂S in the well fluids, and it is therefore necessary periodically to replace the cable. This requires the production tubing to be withdrawn from the wellbore.

It is also known to provide an optical fibre with a casing having sufficient tensile strength to form a self supporting fibre optic cable, which is to say, a fibre optic cable capable of supporting its own weight when it is deployed in a borehole. Since the suspended length of the cable may be measured in kilometres, this is usually achieved by encasing the optical fibre in steel. For example, WO2006/097772 teaches a self supporting fibre optic cable comprising plural concentric layers of stainless steel sheathing which are swaged onto an optical fibre core to form a slickline.

It is possible to form a self supporting fibre optic cable with a diameter which is sufficiently small to allow it to be conveniently stored and transported in coiled form and then injected into the borehole via the Christmas tree valves at the wellhead. The cable must then be withdrawn before the Christmas tree valves or blowout preventer can be closed.

It can be difficult to deploy the cable, particularly in deviated wells, since the flexibility of the cable and its small radius of curvature may cause it to kink and jam in the well casing or production tubing.

Moreover, a self supporting fibre optic cable having a swaged casing of the type mentioned above is effectively isolated from the ambient conditions in the borehole, and so it cannot be used to carry out distributed sensing of a given parameter (e.g. temperature or pressure) along a substantial part of the depth of a borehole.

In some of its aspects the present invention has as a general object to provide a method and apparatus whereby a self supporting fibre optic cable may be more conveniently deployed in and recovered from a borehole.

In a further aspect the present invention has as its object to provide a more convenient distributed sensing apparatus for use in a borehole.

In a yet further aspect the present invention has as its object to provide a method and apparatus whereby two portions of tubing may more satisfactorily be joined together.

In its various aspects the invention provides a method and apparatus as defined in the claims.

Further features and advantages and more specific objectives will be apparent from the various illustrative embodiments which will now be described, purely by way of example and without limitation to the scope of the claims, and with reference to the accompanying drawings, in which:

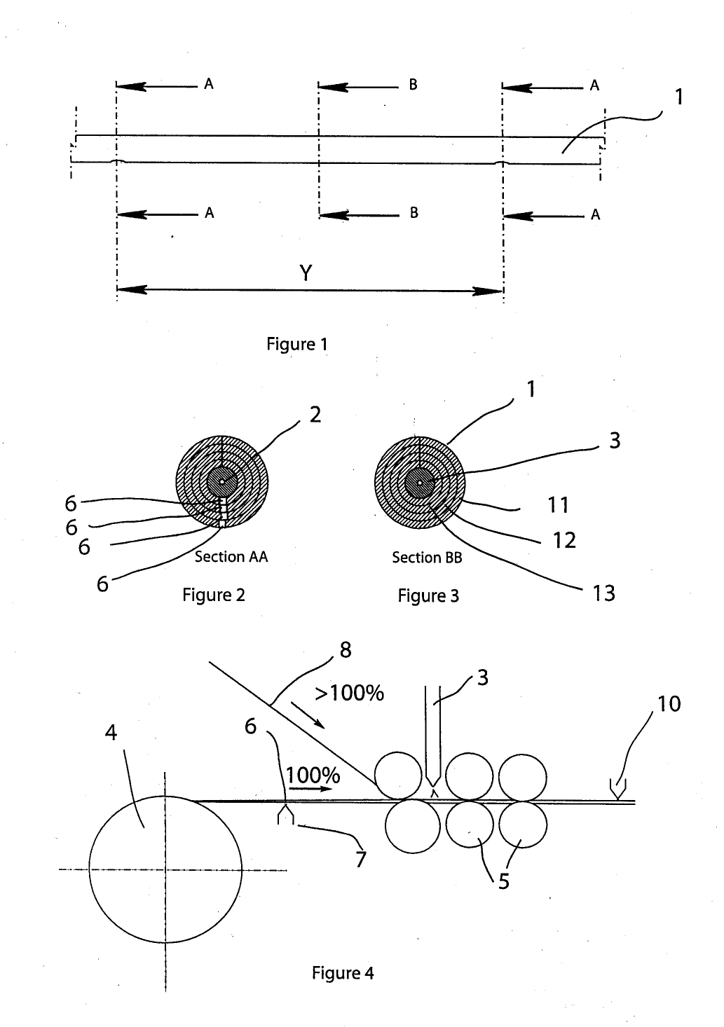

FIG. 1 is a side view of a steel tube, with two sections AA and BB indicated

FIG. 2 is an end view of section AA of FIG. 1

FIG. 3 is an end view of section BB of FIG. 1

FIG. 4 is a schematic of the manufacturing process for the item shown in FIG. 1-3

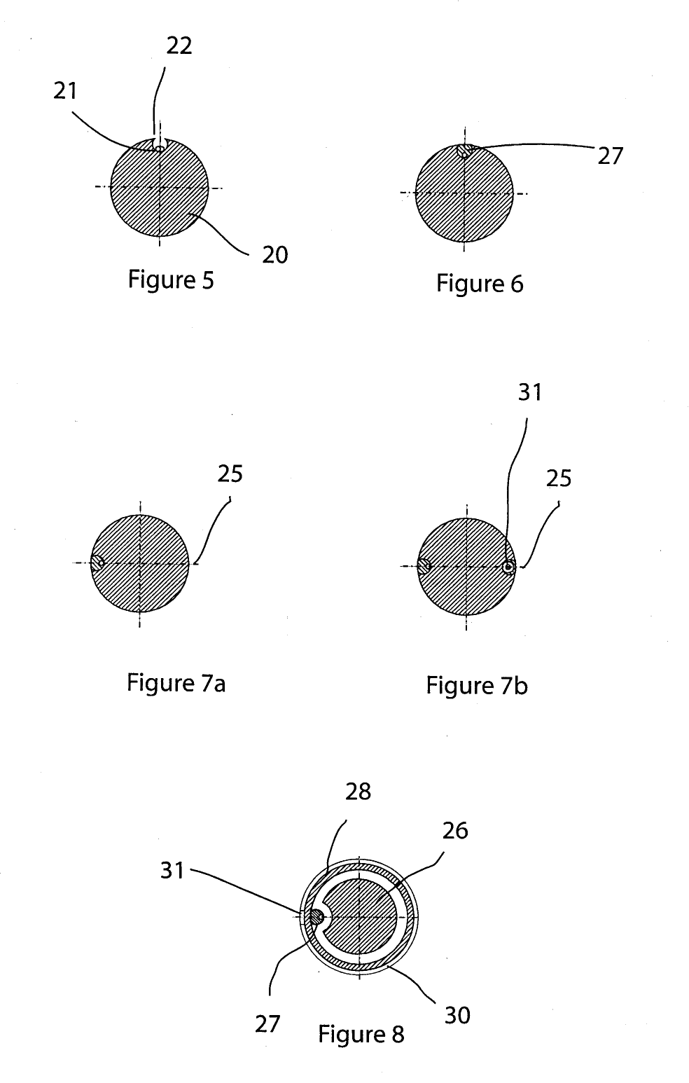

FIG. 5 is an end view of another embodiment

FIG. 6 is a similar view to FIG. 5 with a additional stage in the manufacturing process.

FIG. 7a is a similar view to FIG. 6 with a additional stage in the manufacturing process.

FIG. 7b is a similar view to FIG. 7a with the of an insulated electrical cable.

FIG. 8 is an end view of another embodiment, similar to FIG. 5

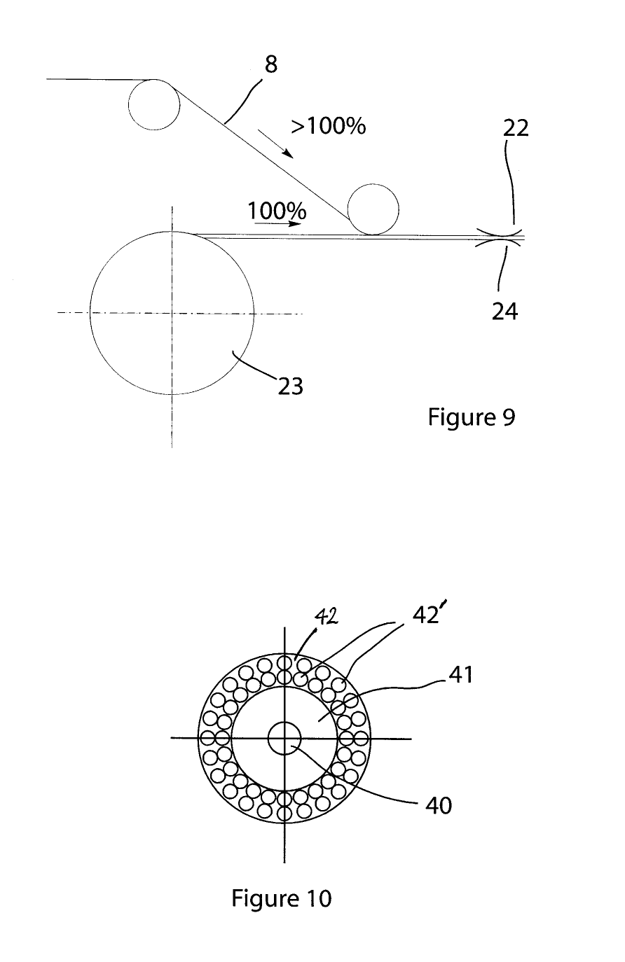

FIG. 9 is a schematic of the manufacturing process for the item shown in FIG. 5-8

FIG. 10 is a cross section view of a self supporting fibre optic cable

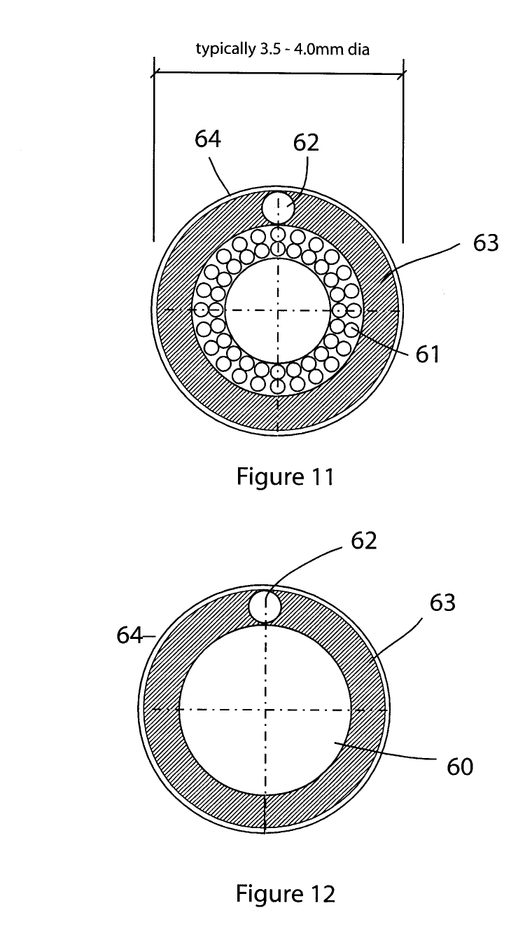

FIG. 11 is a cross section view of a self supporting fibre optic cable, with the fibre mounted very close to the exterior of the assembly

FIG. 12 is a cross section view of another type of self supporting fibre optic cable, with the fibre mounted very close to the exterior of the assembly.

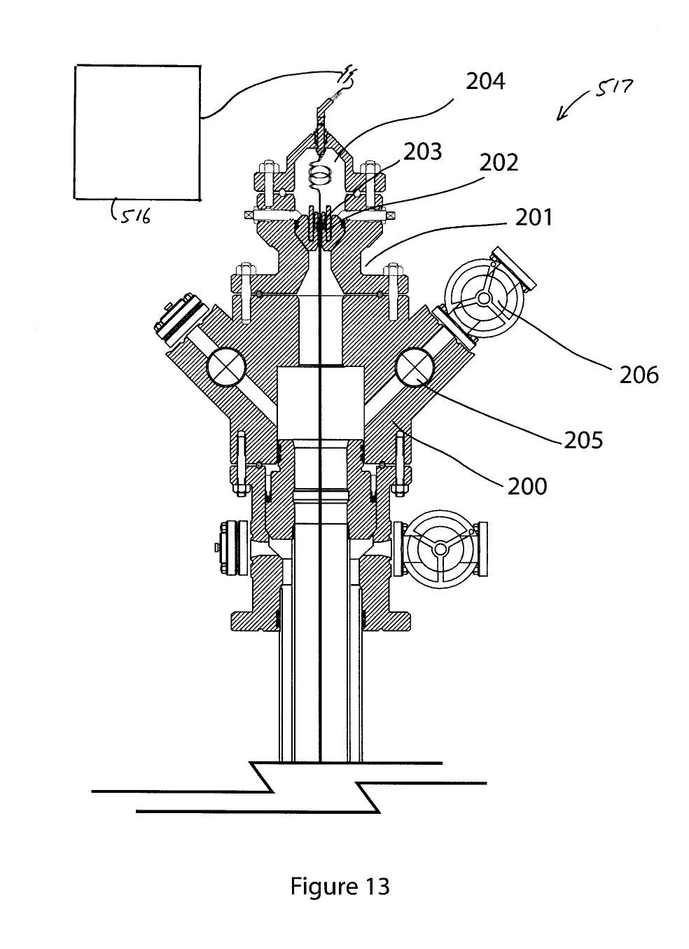

FIG. 13 is a cross section of a horizontal Christmas tree and the fibre optic slickline suspended in it.

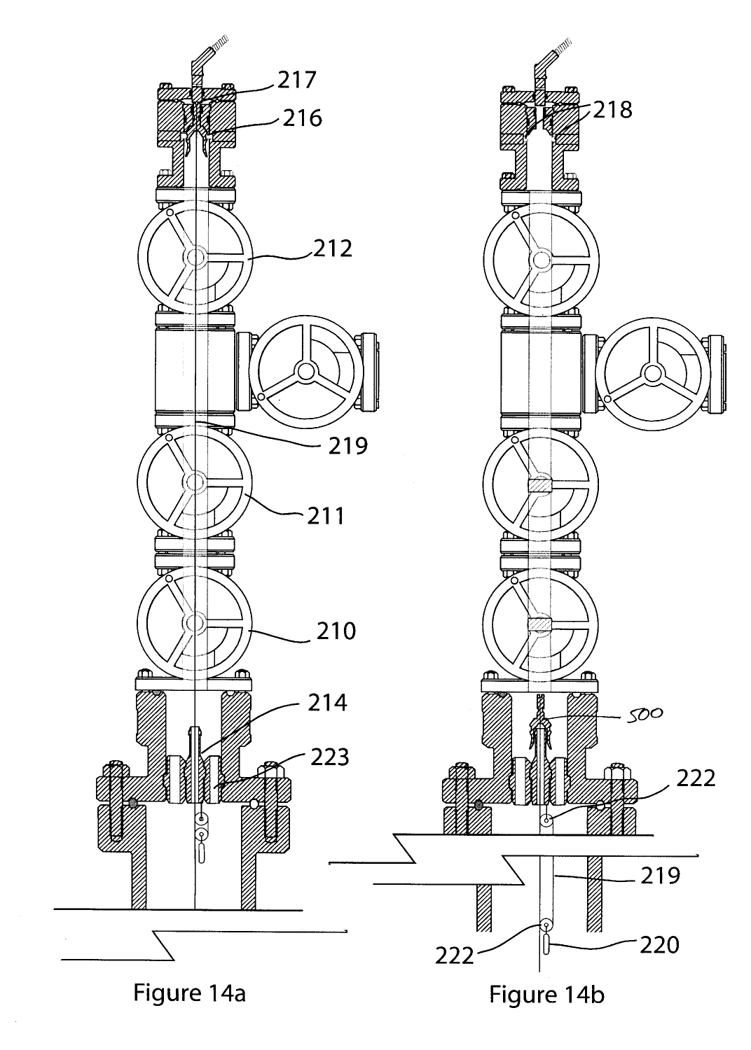

FIG. 14a is a cross section of a traditional vertical Christmas tree and the fibre optic slickline suspended in it.

FIG. 14b is a similar view to FIG. 14a, with the fibre optic cable released and suspending below the closed Christmas tree valves

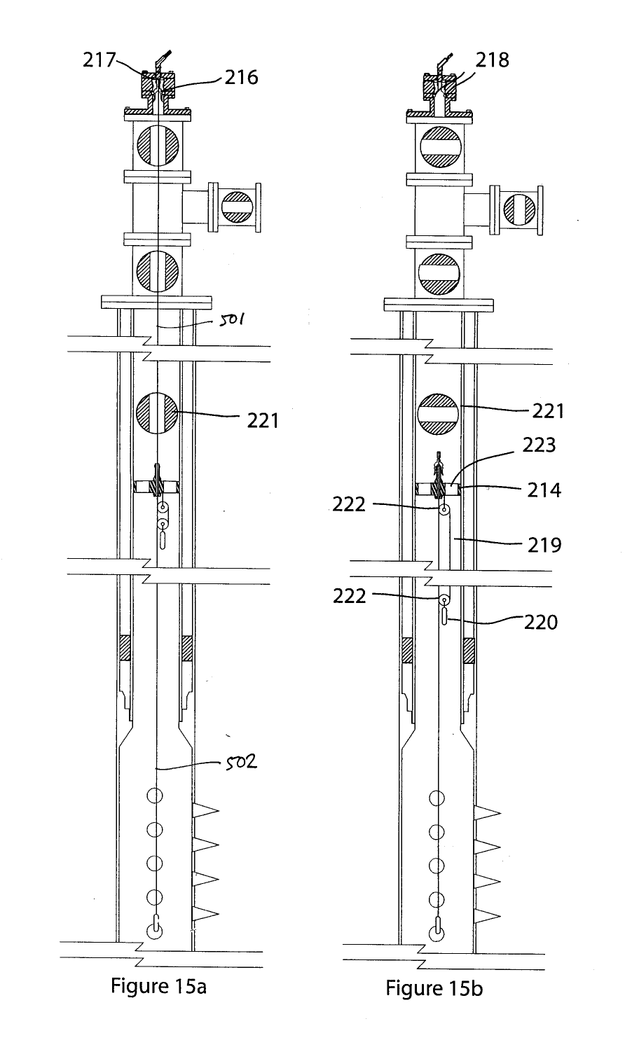

FIG. 15a is a cross section side view of a well including a sub surface safety valve, and a fibre optic cable suspended inside its central bore.

FIG. 15b is a similar view to FIG. 15a, with the fibre optic cable released and suspending below the closed Sub surface safety valve and Christmas tree valves.

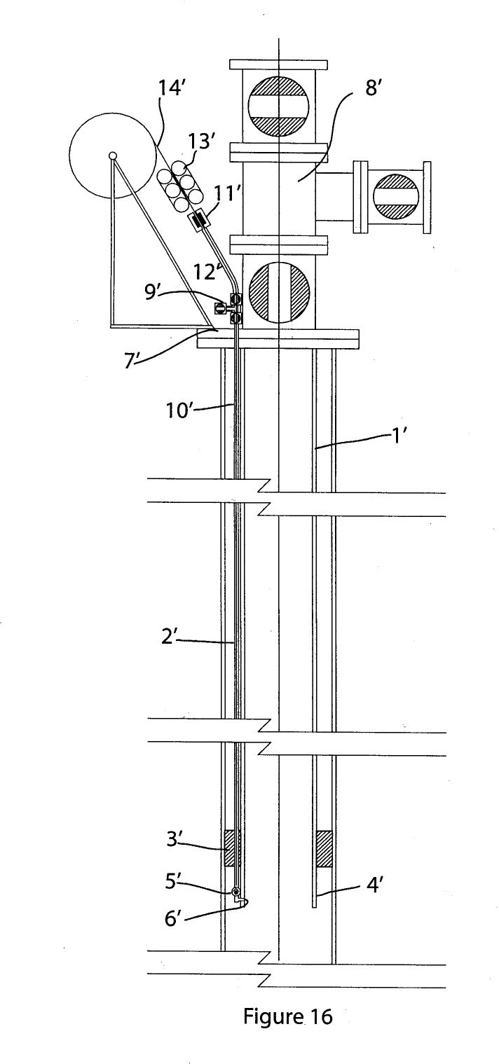

FIG. 16 is a side view of a well with the production tubing installed and a fibre optic cable injection means attached to the side of the Christmas tree.

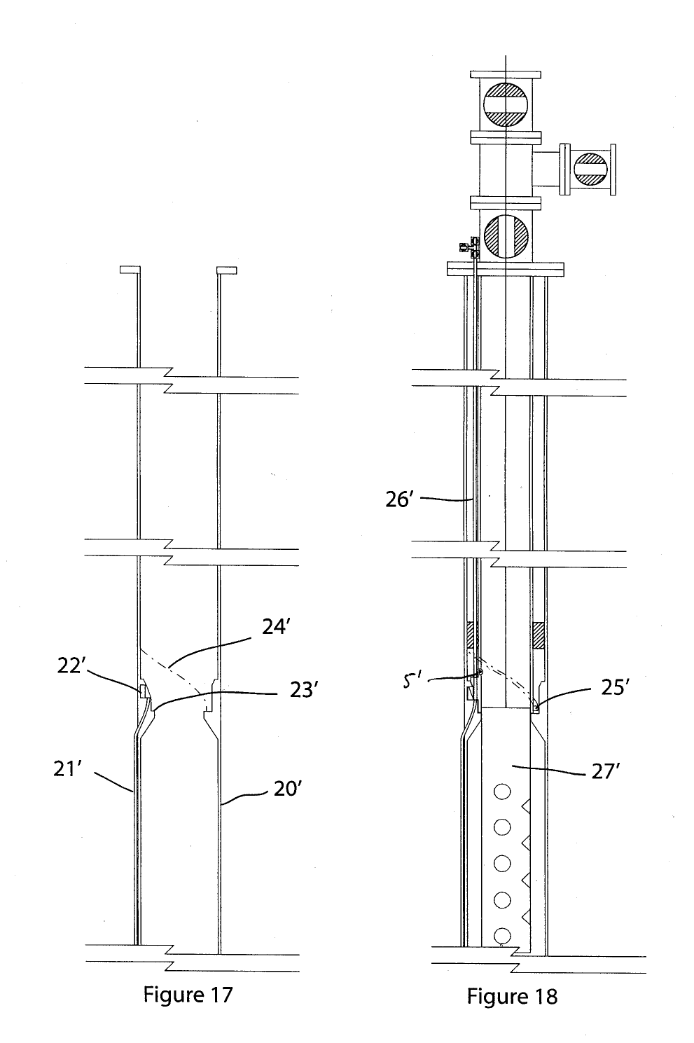

FIG. 17 is a side view of a well with the production casing just cemented.

FIG. 18 is a side view of the same well as shown in FIG. 17 with the production tubing and Christmas tree installed.

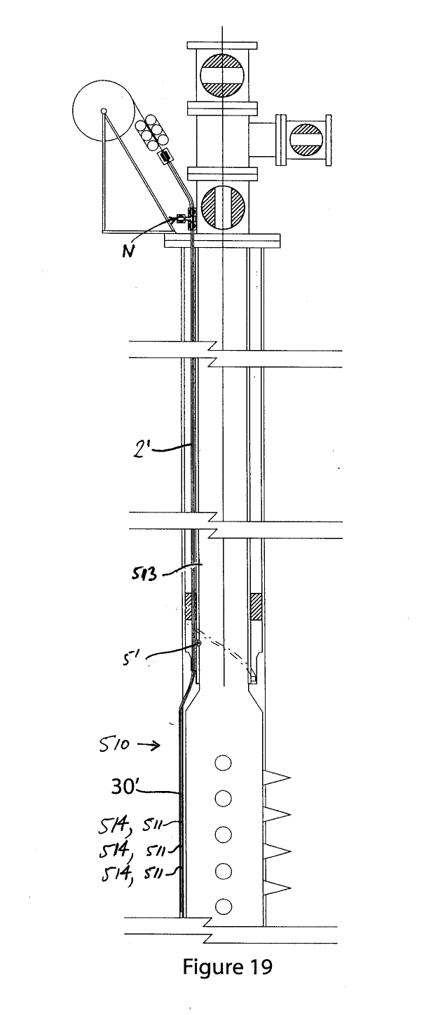

FIG. 19 is the same view of the well as shown in FIG. 18 with the fibre optic cable injected down to the reservoir (behind the casing)

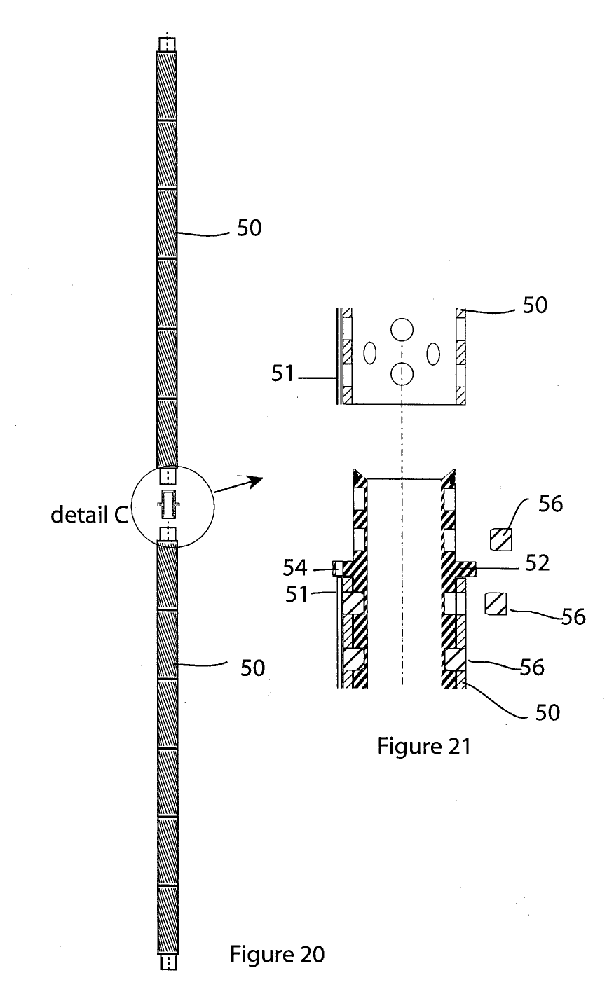

FIG. 20 is a side view of two sections of sand screen being connected, with a means of connecting without rotation highlighted by C

FIG. 21 is a section side view a non rotating connection or a sand screen which is highlighted in FIG. 20 by C

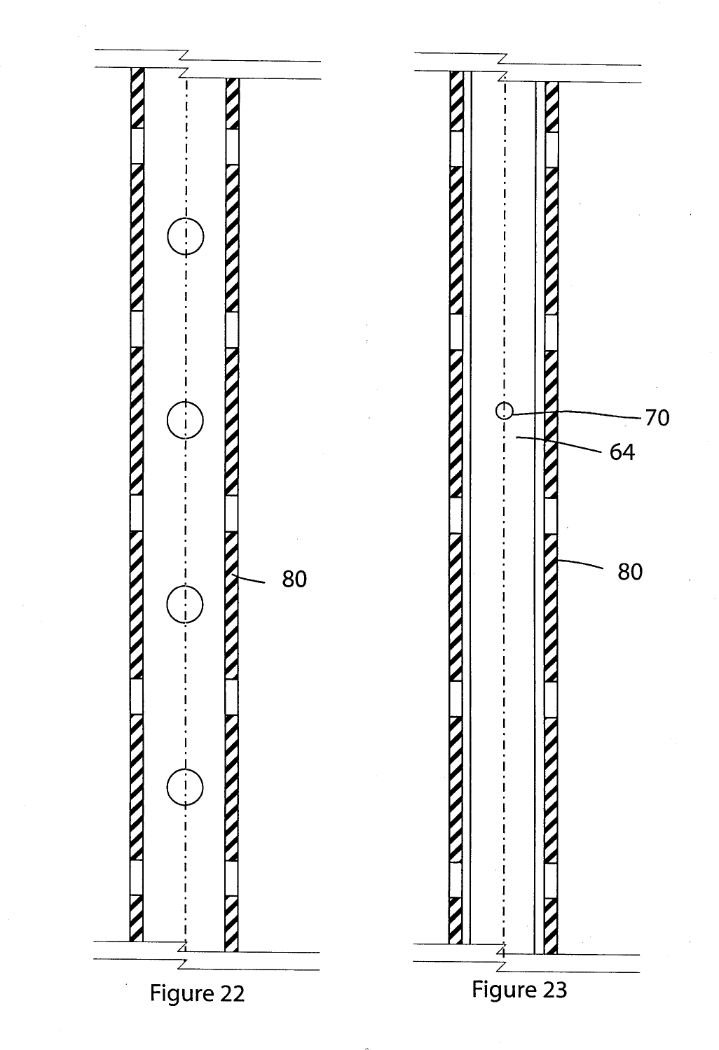

FIG. 22 is a view of a perforated tube situated inside the sand screen or mounted to the outside of the production tubing.

FIG. 23 is the same view as FIG. 12, with the self supporting fibre optic cable inside the perforated tube.

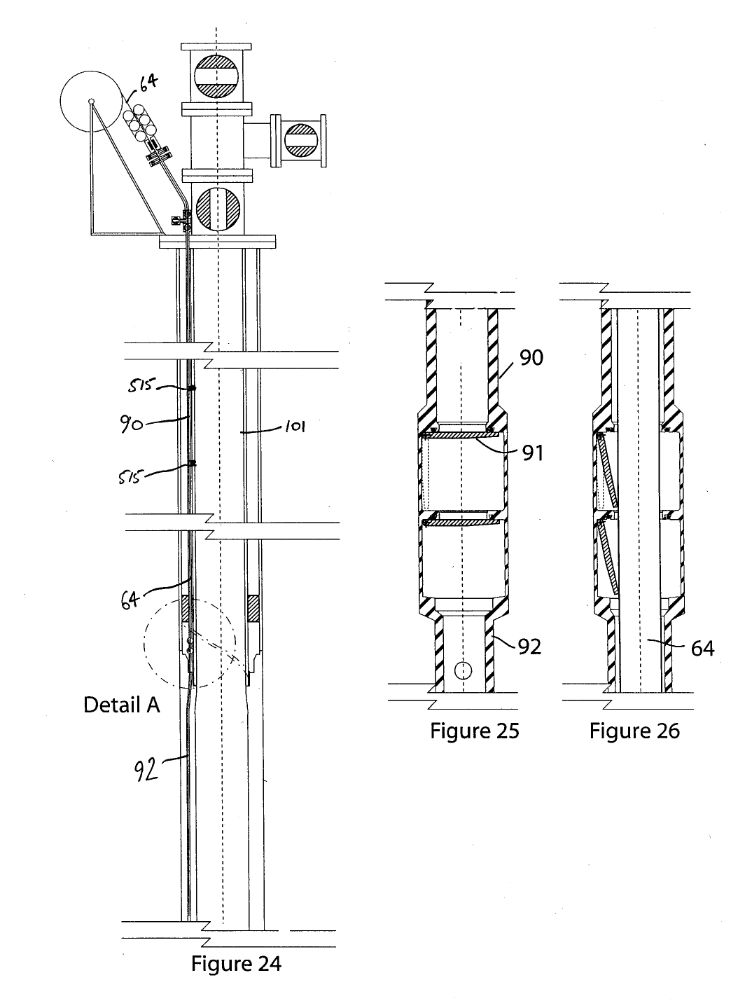

FIG. 24 shows the perforated tube option, across the reservoir and the additional hardware required to ensure the self supporting tubes safe deployment.

FIG. 25 shows a side view of detail a of FIG. 24 which is two non return valves situated at the beginning of the perforated tube.

FIG. 26 shows the same view as FIG. 25, in this instance with the self supporting fibre optic tube opening the non return valves.

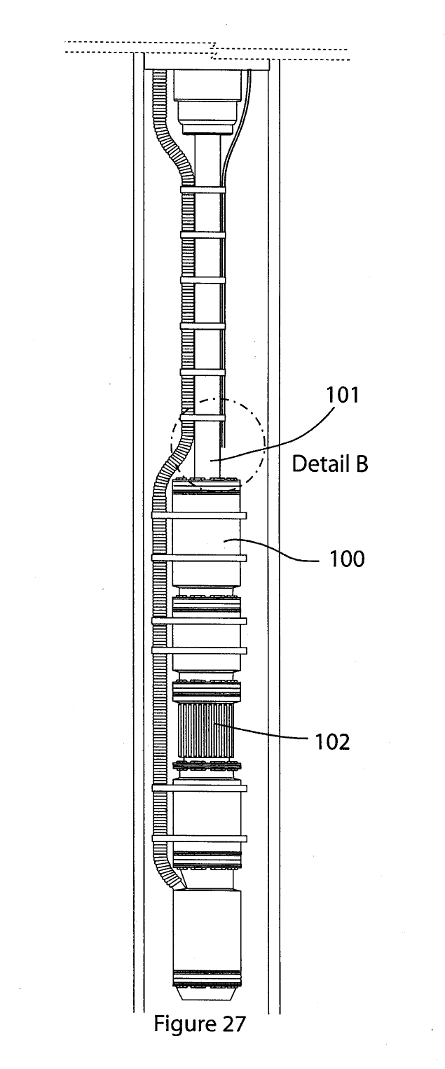

FIG. 27 is a side view of a well with an electrical submersible pump installed and with a detail B highlighted

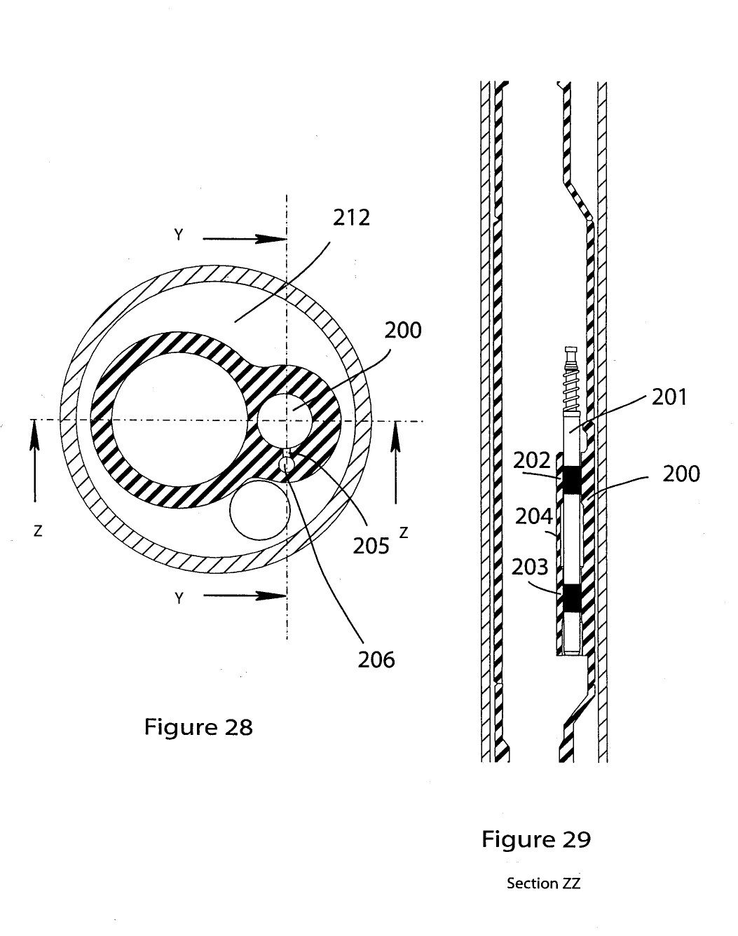

FIG. 28 is a section plan view of detail B in FIG. 27

FIG. 29 is a section side view ZZ in FIG. 28

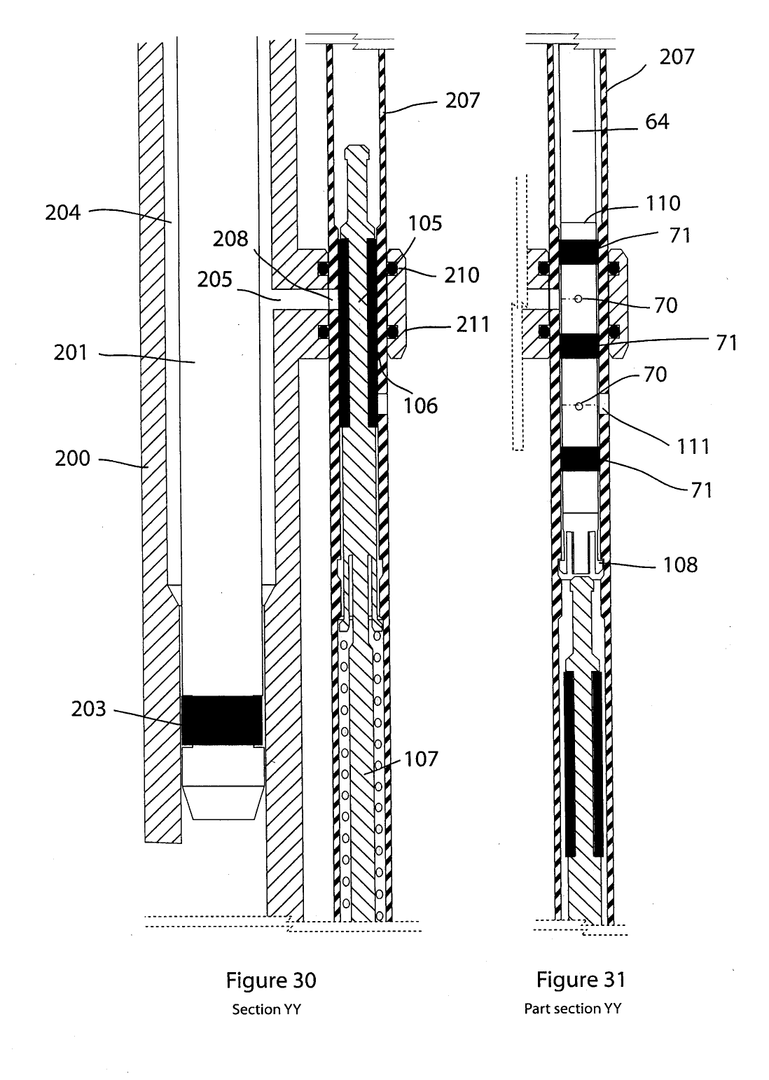

FIG. 30 is a section side view YY in FIG. 28

FIG. 31 is a part section side view YY in FIG. 28

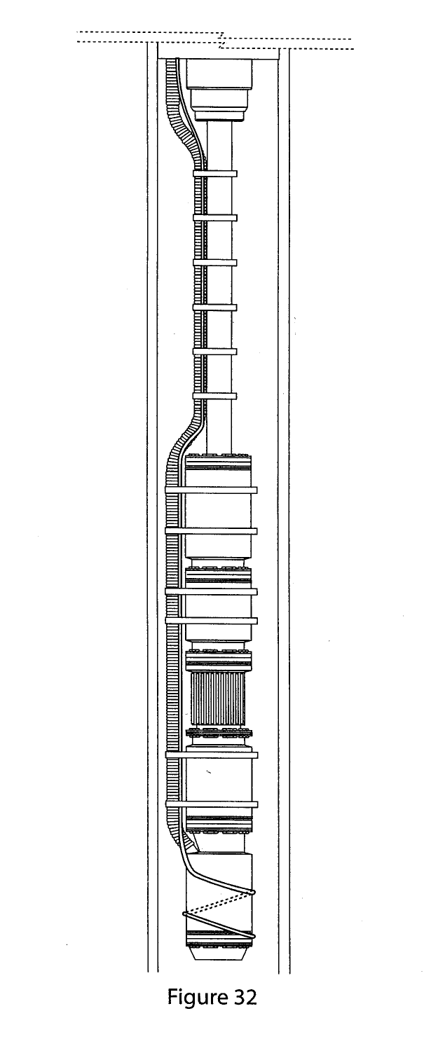

FIG. 32 is a similar view to FIG. 27 with the fibre optic conduit spiral wound around the motor

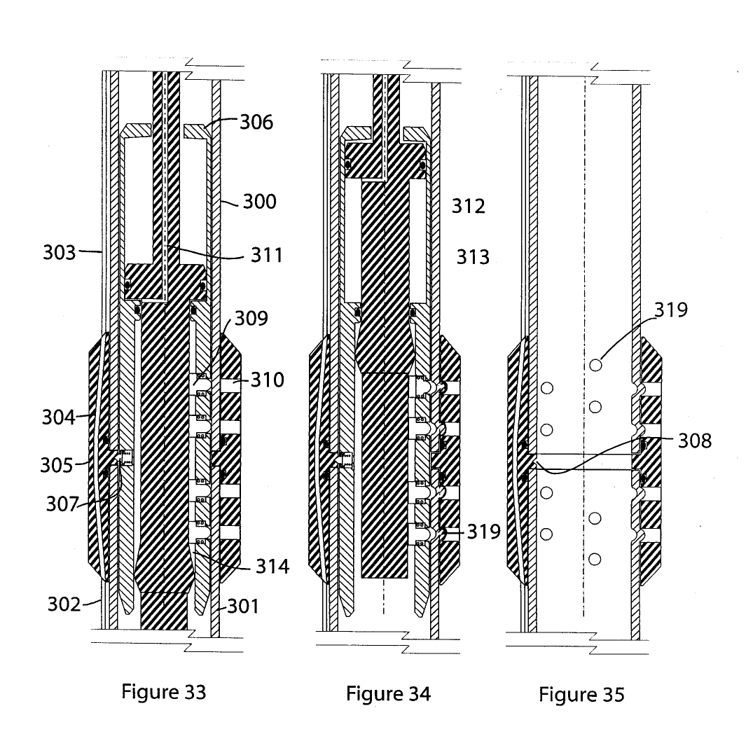

FIG. 33 is a further tubing connector embodiment similar to FIG. 22 but with a flush internal bore. With a internal assembly tool at the start of its position

FIG. 34 is a similar view to FIG. 33 with the assembly tool at the end of its working position.

FIG. 35 is a similar view to FIG. 33 with the assembly tool removed.

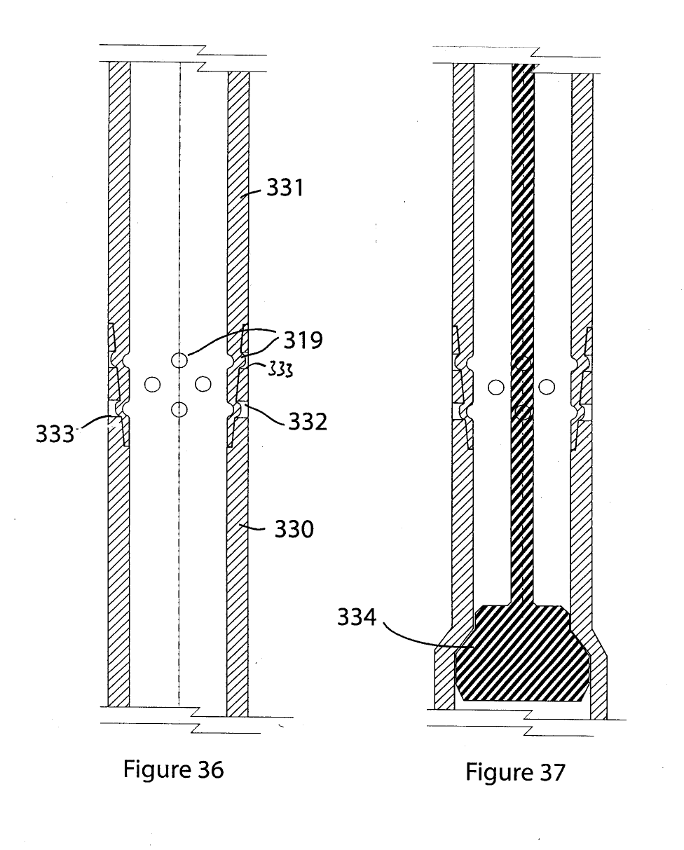

FIG. 36 is a similar connector means as shown in FIGS. 33,34 and 35 in this case the tubing is flush OD and ID but uses a similar setting tool

FIG. 37 is the flush jointed tubing shown in FIG. 36, but all to expanded by an expansion die.

It will be recognised that many of the embodiments described herein are complementary, so that the features of each described embodiment may be used in combination with any other described embodiment as appropriate.

In one embodiment there is provided a distributed sensing apparatus for use in a borehole, including a self supporting fibre optic cable, the cable including at least one optical fibre surrounded by a casing comprising a plurality of concentric tubular steel layers; wherein the tubular steel layers comprise perforations which are aligned to form at least one passage through the casing.

In other embodiments the tubular tensile casing of the cable may consist of a plurality of axial fibrous members, or alternatively may comprise a tube made from a sufficiently strong material, such as steel. The cable may have a steel core, which may be copper clad so that it may transmit electrical power to an electrical device on the end of the cable, such as a “tractor” to enable the cable to crawl to the end of a horizontal section of well.

Alternatively the optical fibre may be located on the outside of the tensile member and may be arranged helically around the tensile member, in which case it is preferably embedded in an elastomeric material. Preferably an outer protective layer such as stainless steel is provided around the elastomeric layer. This enables the Bragg grating sensors or multi mode fibre for carrying out distributed measurement to be in intimate contact with the final protective layer and in sufficient contact with the well pressure, such that when the fibre optic cable is deployed in a conduit with perforations 511 (FIG. 19) along its length, distributed sensing is possible along at least part and, if desired, the whole length of the cable so as to provide useful information such as a pressure profile of the entire well.

Referring to FIGS. 1-4 there is shown a fibre optic cable comprising a casing 1 comprising a plurality of concentric tubular steel layers, in its centre is an optical fibre 2 encapsulated in a settable flexible material 3. The stainless steel is fed off a drum, to a set of rollers 5 which form it into a round tube, while it is still flat, a small hole 6 is cut into the stainless steel by a laser 7 at pre determined intervals Y During the forming process the encapsulated optical fibre 8 is fed into the centre of the tube, generally with a little surplus, and before the tube is fully formed a pourable, flexible sealing material 3 fills the area around the fibre, the tube is hermetically sealed by laser 10 seam welding the tube. Each subsequent stainless steel layer 11, 12 13 added is far simpler, but what is important is to synchronise the position of the hole 6 in each layer, so that at least one passage forming a communication path exists from the outside of the tube to the surface of the settable flexible material 3, which in turn will subject the fibre to the direct temperature and strain at that point.

In other embodiments the cable includes at least one optical fibre surrounded by a casing comprising a plurality of axial fibrous members. Alternatively the cable includes a tensile member and at least one optical fibre, and the optical fibre is located on an outer surface of the tensile member. The optical fibre may be arranged helically around the tensile member. The optical fibre may be embedded in an elastomeric material which is preferably covered by an outer layer of steel.

FIGS. 5 to 9 show another embodiment. A steel wire 20 has a small channel 21 formed into its upper surface. The two outside edges slightly overhang the channel. The steel wire is feed of a drum, at the same time an optical fibre 8 is fed into the channel, generally with a little surplus so that the fibre is not subjected to strain when the steel wire is stretched. The wire and the fibre are fed into a die 24 and a thermoplastic material 27 is injected into the slot to secure the fibre and make the OD of the steel wire flush and capable of holding pressure. The overhang 22 also ensures the set plastic and fibre in addition to be bonded to the metal surface are also mechanically held in place. As the wire wound back onto a storage drum, it is wound at 90 degrees relative to as it was feed into the injection moulding machine. This ensures the fibre is on the neutral axis 25 of the wire. FIG. 7b shows a further insulated electrical wire 31 fitted 180 degrees from the fibre optic cable 21. This could provide a telemetry path to a sensor attached to the end of the steel wire 20. A further embodiment is shown in FIG. 8, where a copper clad steel wire 26 is the core, an identical channel 21 is formed, but the thermoplastic injection moulding both fills the slot 21 and all the outer surface of the wire 28, this enables the wire to both transmit electricity and fibre optic signals. If required an additional stainless steel layer 30 could be added with a small hole 30 added to provide a communication path from the outside of the tube to the surface of the settable flexible material 26, which in turn will subject the fibre to the direct temperature and strain at that point.

Referring to FIGS. 10 there is shown a stiff, self-supporting fibre optic cable. The optical fibre 40 is surrounded by a buffer layer 41 made of thermoplastic, around the outside of the buffer layer 41 is a glass fibre reinforced matrix 42, comprising axial glass fibres 42′ (i.e. fibres extending axially along the cable) set in resin, this results in a light, very stiff and very strong fibre optic cable assembly.

Referring to FIGS. 11 and 12, there are shown the two version of the self supporting fibre optic cable as shown in FIGS. 10. In certain applications it is important to get the fibre optic cable as close to the exterior of the self supporting member as possible. In the embodiment in FIG. 12 the main load bearing member is the stainless steel wire 60, around which a helically wound an optical fibre 62 and encapsulated in an extruded elastomeric jacket 63. In the embodiment of FIG. 11 the load bearing member is the glass fibre matrix 61 which again has a helically wound fibre 62 around it and which is located in an extruded an elastomer jacket 63. This elastomeric jacket 63 protects the fibre and provides a uniform diameter for a final stainless steel layer 64. This final stainless steel layer 64 which forms a hermetic seal to the wellbore fluids. This enables the fibre to be both exposed to temperature and strain effects, and by appling distributed temperature and strain interrogation of the fibre, the pressure and temperature may be determined along the fibre length.

In another embodiment, a method of deploying a self supporting cable in a borehole comprises introducing the cable into the borehole via at least one open valve; securing the cable to a fixture located in the borehole beneath the valve so that a lower end portion 502 of the cable is suspended beneath the fixture; securing an upper end portion 501 of the cable to a releasable connector located above the valve; releasing the connector to allow the upper end portion of the cable to fall through the valve so that the valve may be closed; and then retrieving the upper end portion of the cable via the valve.

The upper end portion 501 of the cable is preferably provided with a termination 500 which is located by the hanger 214 (forming part of the fixture 222, 214) after the connector is released. This enables the connector to be retrieved from the location defined by the hanger. The fixture preferably includes a pulley assembly 222 which is arranged to take up slack in the cable so as to store the upper end portion of the cable when the connector is released.

In the illustrated embodiment, the cable is a fibre optic cable having a relatively small external diameter of about 3.5 mm to 5 mm, although the novel arrangement could alternatively be used with any other cable of relatively small diameter, for example, less than about 10 mm or 15 mm, where it is desired to deploy the cable via the wellhead Christmas tree while allowing the Christmas tree valving to be closed without withdrawing or destroying the cable. The fixture could be removable from the wellbore so that where the cable is a fishing line, objects retrieved by the fishing line could be extracted via the wellhead.

Referring to FIG. 13, there is shown a side view through a horizontal style christmas tree 200. A simple termination of the self supporting fibre optic cable can be placed on its upper flange 201. The termination mechanically 202 takes the weight of the self supporting fibre optic cable and provides a pressure seal 203. The fibre is then spliced to a network cable 204. In the event the well needs to be closed in, the valves 205 and 206 in the production path can be closed and the well can be made secure. The cable is interrogated by a laser beam and/or data is transmitted via the cable by measuring and/or data transmission and control equipment 516 at the wellhead 517.

FIGS. 14a and 14b show an arrangement through a conventional vertical tree. In this case the self supporting fibre optic cable passes through the open Christmas tree valves 210, 211 and 212. In the event the well has to be closed in, the self supporting fibre optic cable would have to be removed. To ensure this can be done quickly and efficiently, the self supporting fibre optic cable passes over a fixture comprising a pulley assembly 222 attached to the hanger 214, which is either set in a profile or has its own slips mechanism if the tubing has no profile, and has sufficient flow by area 223 not to restrict the production from the well, the flexible fibre optic cable 215 passes through the Christmas tree and connects to a releasable connector 216 in the tree cap 217. In the event the Christmas tree valves have to be closed promptly, release grips 218 are activated and the connector drops through the valves and rests on the hanger arrangement 214. the surplus flexible fibre optic cable 219 goes beneath the hanger and is assisted by a weight 220. When the well is opened for production the connector can be fished and reconnected to the connector 217.

FIGS. 15a and 15b show a similar arrangement as FIGS. 14a and 14b, in this case the hanger 214 is set below the sub surface safety valve 221 and the excess fibre 219 goes beneath the hanger assisted by weight 220 and pulley system 222. The pulley system allows no breaks in the fibre optic cable.

In the event the wellhead valves, or the sub surface safety valve need to be closed, this embodiment provides a method of disconnecting the fibre at surface and using a pulley system to store the excess fibre, and let the cable rest at a position below said valves, and later be recoverable so as to continue with the measurements.

In another embodiment, a method of deploying a self supporting fibre optic cable in a borehole comprises arranging a conduit in the borehole, and slidingly injecting the cable into the borehole via the conduit; wherein the conduit has an internal diameter greater than, but not more than three times an external diameter of the cable. Preferably the conduit is much smaller than the production tubing or well casing to which it may be fixed, and has an internal diameter not more than twice an external diameter of the cable. For example, for a cable with an external diameter of 5 mm, in this embodiment the internal diameter of the conduit is less than 15 mm, preferably less than 10 mm. This ensures that the cable runs smoothly along the conduit and solves the problem of kinking and buckling of the small diameter cable as it is injected into the well. The conduit may be fixed (e.g. at the packer 3′) to tubing 4′ in the borehole so that the tubing supports the conduit. A purging gas such as nitrogen may be injected into the conduit around the cable. A lower end portion of the conduit may be provided with a one way valve which prevents wellbore fluids from flowing up the conduit; the valve may be arranged above a perforated portion of the conduit, the perforated portion optionally forming part of a sandscreen and permitting distributed sensing by connecting the cable to the wellbore environment.

The fibre optic cable, with a new sensor connected to its lower end, preferably has sufficient stiffness to urge a preinstalled sensor or blanking sub out of position into to a lower void, being replaced by the new sensor.

A lower end of the fibre optic cable may be connected to a sensor by means of a frangible connection which is arranged to break when a predetermined pulling force is applied to the cable so as to allow the cable to be recovered from the borehole. A sensor may connected to a lower end of the cable before the cable is injected into the borehole, and the cable is slidingly advanced along the conduit until the sensor replaces another sensor (such as the sensor previously detached from the cable) or object (such as a blanking plug) by displacing the another sensor or object from a use position. The new sensor is then installed in the same position as the previous sensor or plug.

In another embodiment, a method of deploying a distributed sensing system in a borehole comprises arranging a conduit in the borehole, and slidingly injecting a self supporting fibre optic cable into the borehole via the conduit; wherein the fibre optic cable is arranged to sense a parameter to be measured at a plurality of points 514 in a measurement region 510 (FIG. 19) extending along at least a part of a length of the cable, and the conduit is perforated with perforations 511 in the measurement region.

The conduit may be fixed to tubing 4′, 513 in the borehole so that the tubing supports the conduit. The conduit preferably has an internal diameter not more than three times, more preferably not more than twice an external diameter of the cable. A lower end portion of the conduit may be provided with a one way valve, which may be located above the perforated measurement region.

Like the previous embodiment, a purging gas N (FIG. 19) may be injected into the conduit around the cable. The conduit may form part of a sandscreen. The cable may include at least one optical fibre surrounded by a perforated tubular casing, which advantageously allows distributed sensing while benefiting from the strength and flexibility of the tubular casing, preferably comprising plural swaged steel layers. Alternatively it may have a different construction, as described with reference to the other embodiments. The fibre optic cable may include an optical fibre with Bragg sensors distributed along at least part of its length.

Referring to FIGS. 16 to 19, attached to the production tubing 1′ is a small diameter conduit 2′, which is referred to hereafter as a capillary tube; it being understood that a “capillary tube” means a small diameter conduit. At its lower end the capillary tube passes through a packer 3′ and into the production tailpipe 4′ via a one way check valve 5′ and port 6′. At the surface, the capillary tube passes from the inside of the well to the outside via a flange 7′ on the Christmas tree 8′. At its exit three valves 9′ are located which can isolate the capillary tube and allow fluids or gas to be pumped down the capillary tube. When it is required to install a length of fibre optic cable 14′, a pack off 11′ is attached to the valves 9′, an extension tube 12′ with a slight inclination maybe required to clear the valves on the tree 8′. A small injector 13′ is attached to the pack off 11′ and the fibre optic cable 14′ can be fed into the injector, which urges the cable into the capillary tube 2′. The fibre optic cable maybe either metal clad by a thin stainless steel layer, or maybe a fibre glass reinforced member which provides both good compressive and tensile capabilities. The fibre optic cable can then be installed to a the total length of the capillary tube.

While installed, fluids maybe pumped along the capillary tube 2′ past the fibre optic cable and then injected into the production tubing, the fluids being chosen, for example to prevent corrosion. In addition, nitrogen N may also be pumped to purge the small tube of any H2S ingress to prevent H2S darkening of the fibre-optic cable.

The conduit can thus be used to convey chemicals into the well. For example, it can be used to continuously purge the area around the fibre optic cable with nitrogen so as to eliminate H2S ingress and hence delay H2S darkening of the optical fibre, prolonging the life of the fibre optic cable.

The conduit may comprises a plurality of perforations 511 along its length which expose the fibre optic cable to the pressure in the well at the location of the each perforation and by means of distributed sensing enables the fibre optic cable to provide a pressure profile along the entire length of the well

The capillary tube may be provided with a one-way valve at its lower end to prevent production fluids rising up the capillary tube when the capillary tube is not in use.

Preferably the self supporting cable can extend beyond the capillary tube and the lower end of the production tube and also through a sand screen via corresponding capillary tubes in the sand screen sections.

Referring to FIGS. 17 to 19, there is shown a production casing 20′ which has a capillary tube 21′ attached to its outside. The production casing is cemented into the reservoir. The capillary tube 21′ enters the casing via a sub 22′ which has a landing shoulder 23′ and an orientation guide surface 24′. referring to FIG. 18, the production tubing has a matching guide pin 25′ which orientates the tubing so that the production tubing's attached capillary tube 26′ is brought into correct alignment with the casing's capillary tube 21′ as the deployed production tubing comes to rest against the landing shoulder. Tubing-conveyed guns maybe used to access the reservoir; if they are, they can be oriented using guide pins and the orientation guide surface 24′ in the manner already described. so that when they are fired they do not damage the capillary tube 21′. The completion could also comprise a sand screen, so no perforating would be performed. Finally the fibre 30′ could be injected to the end of the reservoir and monitoring of the entire reservoir would be possible.

In another embodiment, a method of joining first and second tubing portions comprises forming a plurality of holes in the second tubing portion; arranging the first tubing portion inside the second tubing portion; arranging a tool inside the first tubing portion; and operating the tool to deform the first tubing portion so as to form dimples which extend into the holes.

This forms an assembly comprising a first tubing portion fixed inside a second tubing portion, wherein the second tubing portion comprises a plurality of holes, and the first tubing portion comprises a plurality of dimples which extend into the holes.

The tubing portions may form part of a sandscreen for use in a borehole, in which case a wall of the sandscreen may include a conduit (capillary tube) as described above of smaller diameter than the tubing portions, the conduit including axially aligned first and second portions which extend respectively along the first and second tubing portions.

Advantageously, the dimples prevent torsional or axial movement between the tubing portions.

Referring to FIGS. 20 and 21 there is shown a method for joining sections of sand screen 50 together so that they are aligned with each other. A capillary tube 51 is arranged along side each of two sections of a sand screen and is embedded in the sand screen As each sand screen section 50 is assembled the tubes 51 need to be aligned with each other. Pre drilled holes in the end of each screen align with holes drilled into a connecting coupling 52. Interference fit dowels are hammered into the aligned holes and the joints are connected together, with the capillary tubes 51 perfectly in line.

Referring to FIGS. 22 to 23, there is shown a perforated tube, this is located inside a sand screen, or along the production path in the reservoir. The self supporting fibre optic cable 64 is deployed inside this tube, so that is may be easily injected the entire length of the tube, because it is supported, even though the pressure in the reservoir is exposed along the entire length of the tube. Either a bragg grating sensor will measure point measurements or the distributed measurement process can be employed to measure the distributed temperature and pressure along the entire length exposed.

Referring to FIGS. 24 to 26, the deployment of the fibre optic cable in the production part of the well is shown. In this embodiment the capillary tube 90 is strapped 515 to the production tubing 101. When the self-supporting fibre optic cable is not in the capillary tube 104, ideally it is preferred to prevent production fluids from coming back up the capillary tube 90. One method to prevent this will be to use a dual non return flapper valve 91 located just prior to the perforated conveyance tube 92. When the self supporting fibre optic cable 64 is installed the flapper valves 91 will be opened and wellbore fluid and pressure will be able to migrate to surface. During insertion of the fibre optic cable 64, conventional pressure control equipment is used in a known manner to enable safe deployment, and the self supporting fibre optic cable 64 would be terminated at surface with a known penetrator style bulkhead.

Referring to FIGS. 27 to 32, there is shown an example of an application of the fibre optic cable sensor of the invention with an electrical submersible pump 100.

In this application the pump discharge travels up the production tubing 101, and the wellbore fluid being drawn into the pump via the pump inlet 102. It is very useful to monitor the pump inlet and discharge pressure to optimise the performance of the pump 100. At detail B, is a side pocket mandrel arrangement 200 with a blanking mandrel 201 with seals 202 and 203 isolating chamber 204. Port 205 connects the chamber 204 to bore 206. The hydraulic conduit 207 connects to bore 206, and a port 208 allows communication to the inside of conduit 207 and chamber 204. Seals 210, 211 either side of port 208 isolate the annulus 212.

A blanking sub 105 with seal 106 isolating the port 208.

When it is desired to place a pressure sensor across the port, the sensing section which would consist of ports 70 and seals 71 would be deployed on the end of the self supporting fibre optic cable 64, this would be lowered down the capillary tubing 204 and displace the blanking sub 105 into a lower area 107. A collet arrangement 108 would locate the sensor and provide positive feedback to surface. When correctly aligned, discharge pressure would be measured through port 208 and inlet pressure through port 111. Before the discharge pressure could be measured, the blanking mandrel 201 would have to be retrieved using slickline type tool, well understood in the industry. If the sensor fails for any reason, the blanking mandrel 201 would be run back into the well to isolate the chamber 204. The self supporting fibre optic cable 64 may then be recovered to surface. A new fibre cable can be deployed and the process repeated.

Referring to FIGS. 33 to 37, there is shown a method of joining two portions (“joints”) of tubing 300, 301, where they need to be precisely orientated, so that the capillary tube 302, 303 are perfectly aligned with a third hole 304 in the connecting coupling 305. A setting tool 306 is orientated to the connecting coupling 305 with a spring loaded pin 307 which locates in a unique tapered hole 308, i.e. a tapered hole which provides only one locating position for the pin, so that the top hat pins 309 in the setting tool are perfectly aligned with the holes 310 in the connecting coupling (FIG. 33). When hydraulic pressure is applied down a channel 311 a chamber 312 is energised, which forces the mandrel 313 in the upward direction. As it moves up a tapered ramp 314 energises each row of top hat pins 309, causing them to deform the tube 319 into the hole 310 of the coupling 305 (FIG. 34). Once at the end of its stroke the tool can be pulled out of the top of the tube 300 (FIG. 35) and the process can be repeated at the next coupling. The deformed dimples 319 distribute the torsional, tensile and internal pressure loads the coupling is subjected to so as to prevent axial or rotational movement at the joint between the lengths of tubing. An elastomer seal 320 provides positive sealing capability.

Referring to FIGS. 36 and 37, in some cases it maybe preferred to have flush jointed tubing 330, 331, in which case where they couple together, a tapered connection 332 would be provided, and the holes 333 would be part of the tube 330. The dimples 319 would be made by the same type of setting tool.

The tubes 330, 331 could then be subjected to further expansion, by an expansion die 334. As the tubes are mechanically dimpled together they are not subject to springing apart such as with threaded couplings.

The tubular portions of the sand screen may be joined in a aligned way such that a first conduit associated with the first section and a second conduit associated with the second section are aligned, allowing the installation and removal of a fibre optic cable via the conduit.

In summary, a self supporting fibre optic cable is slidingly deployed in a borehole via a small diameter conduit which may be perforated to enable distributed sensing over at least part of the length of the cable. The cable may comprise a casing made from plural concentric tubular steel layers with aligned perforations. In another embodiment, a cable is deployed via wellhead valving and suspended from a fixture comprising a pulley assembly located beneath the valving. The pulley assembly takes up slack in the cable when the upper end of the cable is released, allowing the cable to fall through the valving so that the valving can be closed. The upper end of the cable includes a termination which is located by the fixture so that it can be retrieved. In another embodiment, two concentric tubing portions are joined by forming dimples in the inner tubing portion which extend into holes the outer tubing portion.

1. A distributed sensing system in a borehole, comprising:
a conduit arranged in the borehole, and
a self supporting fibre optic cable slidably disposed in the conduit;
wherein the fibre optic cable is arranged to sense a parameter to be measured at a plurality of points in a measurement region extending along at least a part of a length of the cable, and
the conduit is perforated in the measurement region.

2. A distributed sensing system according to claim 1, wherein the conduit has an internal diameter not more than three times an external diameter of the cable.

3. A distributed sensing system according to claim 1, wherein the conduit has an internal diameter not more than twice an external diameter of the cable.

4. A distributed sensing system according to claim 1, wherein the conduit is fixed to tubing in the borehole so that the tubing supports the conduit.

5. A distributed sensing system according to claim 1, wherein the conduit forms part of a sandscreen.

6. A distributed sensing system according to claim 1, wherein the cable includes at least one optical fibre surrounded by a perforated tubular casing.

7. A distributed sensing system according to claim 6, wherein the casing comprises a plurality of concentric tubular steel layers, and the tubular steel layers comprise perforations which are aligned to form at least one passage through the casing.

8. A distributed sensing system according to claim 1, wherein the cable includes at least one optical fibre surrounded by a casing comprising a plurality of axial fibrous members.

9. A distributed sensing system according to claim 1, wherein the cable includes a tensile member and at least one optical fibre, and the optical fibre is located on an outer surface of the tensile member.

10. A distributed sensing system according to claim 9, wherein the optical fibre is arranged helically around the tensile member.

11. A distributed sensing system according to claim 9, wherein the optical fibre is embedded in an elastomeric material.

12. A distributed sensing system according to claim 11, wherein the elastomeric material is covered by an outer layer of steel.

13. A distributed sensing system according to claim 1, wherein the fibre optic cable includes an optical fibre with Bragg sensors distributed along at least part of its length.

14. A distributed sensing system according to claim 1, wherein a lower end portion of the conduit is provided with a one way valve.

15. A distributed sensing system according to claim 14, wherein the one way valve is located above the measurement region.

16. A method of deploying a distributed sensing system in a borehole, comprising:
arranging a conduit in the borehole, and
slidingly injecting a self supporting fibre optic cable into the borehole via the conduit;
wherein the fibre optic cable is arranged to sense a parameter to be measured at a plurality of points in a measurement region extending along at least a part of a length of the cable, and
the conduit is perforated in the measurement region.

17. A method according to claim 16, including fixing the conduit to tubing in the borehole so that the tubing supports the conduit.

18. A method according to claim 16, wherein the conduit has an internal diameter not more than three times an external diameter of the cable.

19. A method according to claim 16, wherein the conduit has an internal diameter not more than twice an external diameter of the cable.

20. A method according to claim 16, wherein a purging gas is injected into the conduit around the cable.

21.-43. (canceled)
